(19) United States
(12) Patent Application Publication
(10) Pub. No.: US 2021/0312289 A1
(43) Pub. Date: Oct. 7, 2021

(54) DATA PROCESSING METHOD AND APPARATUS, AND STORAGE MEDIUM

(71) Applicant: SHENZHEN SENSETIME TECHNOLOGY CO., LTD., Shenzhen (CN)

(72) Inventors: Ping LUO, Shenzhen (CN); Lingyun WU, Shenzhen (CN); Zhanglin PENG, Shenzhen (CN); Ruimao ZHANG, Shenzhen (CN); Jiamin REN, Shenzhen (CN); Wenqi SHAO, Shenzhen (CN)

(73) Assignee: SHENZHEN SENSETIME TECHNOLOGY CO., LTD., Shenzhen (CN)

(21) Appl. No.: 17/352,219

(22) Filed: Jun. 18, 2021

Related U.S. Application Data
(63) Continuation of application No. PCT/CN2019/083642, filed on Apr. 22, 2019.

(30) Foreign Application Priority Data
Feb. 25, 2019 (CN) 201910139050.0

(51) Int. Cl. G06N 3/08; G06N 3/04

(52) U.S. Cl. CPC G06N 3/08; G06N 3/04

(57) ABSTRACT

The present disclosure relates to a data processing method and apparatus, and a storage medium. The method includes: inputting input data into a neural network model to obtain feature data currently output by a network layer in the neural network model (S100); determining, according to transformation parameters of the neural network model, a normalization mode matched with the feature data (S200), wherein the transformation parameters are used for adjusting a statistical range of statistics of the feature data, and the statistical range is used for representing the normalization mode; and performing normalization processing on the feature data according to the determined normalization mode to obtain normalized feature data (S300). According to embodiments of the present disclosure, the purpose of autonomously learning a matched normalization mode for each normalization layer of the neural network model can be implemented without human intervention.

### CROSS-REFERENCE TO RELATED APPLICATIONS

The present application is a bypass continuation of and claims priority under 35 U.S.C. § 111(a) to PCT Application. No. PCT/CN2019/083642, filed on Apr. 22, 2019, which claims priority to Chinese Patent Application No. 201910139050.0, filed to the Chinese Patent Office on Feb. 25, 2019 and entitled “DATA PROCESSING METHOD AND APPARATUS, ELECTRONIC DEVICE, AND STORAGE MEDIUM”, each of which is incorporated herein by reference in its entirety.

### TECHNHICAL FIELD

The present disclosure relates to the field of computer vision technologies, and in particular, to a data processing method and apparatus, an electronic device, and a storage medium.

### BACKGROUND

In challenging tasks such as natural language processing, voice recognition, and computer vision, various normalization techniques become essential modules for deep learning. A normalization technique refers to performing normalization processing on input data in a neural network, so that the data becomes a distribution of which the mean value is 0 and the standard deviation is 1 or a distribution of which the range is 0-1 so as to make the neural network easy to converge.

### SUMMARY

The present disclosure provides a data processing method and apparatus, an electronic device, and a storage medium.

According to one aspect of the present disclosure, a data processing method is provided, including:

inputting input data into a neural network model to obtain feature data currently output by a network layer in the neural network model;

determining, according to transformation parameters of the neural network model, a normalization mode matched with the feature data, where the transformation parameters are used for adjusting a statistical range of statistics of the feature data, and the statistical range is used for representing the normalization mode; and

performing normalization processing on the feature data according to the determined normalization mode to obtain normalized feature data.

In a possible implementation, the method further includes:

obtaining multiple corresponding sub-matrices based on learnable gating parameters set in the neural network model; and

performing inner product operation on the multiple sub-matrices to obtain the transformation parameters.

In a possible implementation, the obtaining the multiple corresponding sub-matrices based on the learnable gating parameters set in the neural network model includes:

using a sign function to process the gating parameters to obtain a binarization vector;

using a permutation matrix to permute elements in the binarization vector to generate a binarization gating vector; and

obtaining the multiple sub-matrices based on the binarization gating vector, a first fundamental matrix, and a second fundamental matrix.

In a possible implementation, the transformation parameters include a first transformation parameter, a second transformation parameter, a third transformation parameter, and a fourth transformation parameter; and

a dimension of the first transformation parameter and a dimension of the third transformation parameter are based on a batch size dimension of the feature data, and a dimension of the second transformation parameter and a dimension of the fourth transformation parameter are based on a channel dimension of the feature data;

where the batch size dimension is the number of pieces of data in a data batch where the feature data is located, and the channel dimension is the number of channels of the feature data.

In a possible implementation, the determining, according to the transformation parameters of the neural network, the normalization mode matched with the feature data includes:

determining the statistical range of the statistics of the feature data as a first range, where the statistics include a mean value and a standard deviation;

adjusting the statistical range of the mean value from the first range to a second range according to the first transformation parameter and the second transformation parameter;

adjusting the statistical range of the standard deviation from the first range to a third range according to the third transformation parameter and the fourth transformation parameter; and

determining the normalization mode based on the second range and the third range.

In a possible implementation, the first range is each channel range of each piece of sample feature data of the feature data.

In a possible implementation, the performing normalization processing on the feature data according to the determined normalization mode to obtain normalized feature data includes:

obtaining the statistics of the feature data in accordance with the first range; and

performing normalization processing on the feature data based on the statistics, the first transformation parameter, the second transformation parameter, the third transformation parameter, and the fourth transformation parameter so as to obtain the normalized feature data.

In a possible implementation, the performing normalization processing on the feature data based on the statistics, the first transformation parameter, the second transformation parameter, the third transformation parameter, and the fourth transformation parameter so as to obtain the normalized feature data includes:

obtaining a first normalization parameter based on the mean value, the first transformation parameter, and the second transformation parameter;

obtaining a second normalization parameter based on the standard deviation, the third transformation parameter, and the fourth transformation parameter; and

performing normalization processing on the feature data according to the feature data, the first normalization parameter, and the second normalization parameter so as to obtain the normalized feature data.

In a possible implementation, the transformation parameters include binarization matrices, and the value of each element in the binarization matrices is 0 or 1.

In a possible implementation, the gating parameters are vectors having continuous values;

where the number of values in the gating parameters is consistent with the number of the sub-matrices.

In a possible implementation, the first fundamental matrix is an all-ones matrix, and the second fundamental matrix is a unit matrix.

In a possible implementation, before inputting the input data into the neural network model to obtain the feature data currently output by the network layer in the neural network model, the method further includes:

training the neural network model based on a sample data set to obtain a trained neural network model,

where input data in the sample data set has label information.

In a possible implementation, the neural network model includes at least one network layer and at least one normalization layer;

where the training the neural network model based on the sample data set includes:

performing feature extraction on the input data in the sample data set by means of the network layer to obtain prediction feature data;

performing normalization processing on the prediction feature data by means of the normalization layer to obtain normalized prediction feature data;

obtaining a network loss according to the prediction feature data and the label information; and

adjusting the transformation parameters in the normalization layer based on the network loss.

According to one aspect of the present disclosure, a data processing apparatus is further provided, including:

a data inputting module, configured to input input data into a neural network model to obtain feature data currently output by a network layer in the neural network model;

a mode determining module, configured to determine, according to transformation parameters of the neural network model, a normalization mode matched with the feature data, where the transformation parameters are used for adjusting a statistical range of statistics of the feature data, and the statistical range is used for representing the normalization mode; and

a normalization processing module, configured to perform normalization processing on the feature data according to the determined normalization mode to obtain normalized feature data.

In a possible implementation, the apparatus further includes:

a sub-matrix obtaining module, configured to obtain multiple corresponding sub-matrices based on learnable gating parameters set in the neural network model; and

a transformation parameter obtaining module, configured to perform inner product operation on the multiple sub-matrices to obtain the transformation parameters.

In a possible implementation, the sub-matrix obtaining module includes:

a parameter processing sub-module, configured to use a sign function to process the gating parameters to obtain a binarization vector;

an element permuting sub-module, configured to use a permutation matrix to permute elements in the binarization vector to generate a binarization gating vector; and

a sub-matrix obtaining sub-module, configured to obtain the multiple sub-matrices based on the binarization gating vector, a first fundamental matrix, and a second fundamental matrix.

In a possible implementation, the transformation parameters include a first transformation parameter, a second transformation parameter, a third transformation parameter, and a fourth transformation parameter; and

a dimension of the first transformation parameter and a dimension of the third transformation parameter are based on a batch size dimension of the feature data, and a dimension of the second transformation parameter and a dimension of the fourth transformation parameter are based on a channel dimension of the feature data;

where the batch size dimension is the number of pieces of data in a data batch where the feature data is located, and the channel dimension is the number of channels of the feature data.

In a possible implementation, the mode determining module includes:

a first determining sub-module, configured to determine the statistical range of the statistics of the feature data as a first range, where the statistics include a mean value and a standard deviation;

a first adjusting sub-module, configured to adjust the statistical range of the mean value from the first range to a second range according to the first transformation parameter and the second transformation parameter;

a second adjusting sub-module, configured to adjust the statistical range of the standard deviation from the first range to a third range according to the third transformation parameter and the fourth transformation parameter; and

a mode determining sub-module, configured to determine the normalization mode based on the second range and the third range.

In a possible implementation, the first range is each channel range of each piece of sample feature data of the feature data.

In a possible implementation, the normalization processing module includes:

a statistics obtaining sub-module, configured to obtain the statistics of the feature data in accordance with the first range; and

a normalization processing sub-module, configured to perform normalization processing on the feature data based on the statistics, the first transformation parameter, the second transformation parameter, the third transformation parameter, and the fourth transformation parameter so as to obtain the normalized feature data.

In a possible implementation, the normalization processing sub-module includes:

a first parameter obtaining unit, configured to obtain a first normalization parameter based on the mean value, the first transformation parameter, and the second transformation parameter;

a second parameter obtaining unit, configured to obtain a second normalization parameter based on the standard deviation, the third transformation parameter, and the fourth transformation parameter; and

a data processing unit, configured to perform normalization processing on the feature data according to the feature data, the first normalization parameter, and the second normalization parameter so as to obtain the normalized feature data.

In a possible implementation, the transformation parameters include binarization matrices, and the value of each element in the binarization matrices is 0 or 1.

In a possible implementation, the gating parameters are vectors having continuous values;

where the number of values in the gating parameters is consistent with the number of the sub-matrices.

In a possible implementation, the first fundamental matrix is an all-ones matrix, and the second fundamental matrix is a unit matrix.

In a possible implementation, the apparatus further includes:

a model training module, configured to train, before the data inputting module inputs the input data into the neural network model to obtain the feature data currently output by the network layer in the neural network model, the neural network model based on a sample data set to obtain a trained neural network model,

where input data in the sample data set has label information.

In a possible implementation, the neural network model includes at least one network layer and at least one normalization layer;

where the model training module includes:

a feature extracting sub-module, configured to perform feature extraction on the input data in the sample data set by means of the network layer to obtain prediction feature data;

a prediction feature data obtaining sub-module, configured to perform normalization processing on the prediction feature data by means of the normalization layer to obtain normalized prediction feature data;

a network loss obtaining sub-module, configured to obtain a network loss according to the prediction feature data and the label information; and

a transformation parameter adjusting sub-module, configured to adjust the transformation parameters in the normalization layer based on the network loss.

According to one aspect of the present disclosure, an electronic device is further provided, including:

a processor; and

a memory configured to store processor-executable instructions;

where the processor is configured to execute the method according to any one of the foregoing.

According to one aspect of the present disclosure, a computer-readable storage medium is further provided, having computer program instructions stored thereon, where when the computer program instructions are executed by a processor, the method according to any one of the foregoing is implemented.

In the embodiments of the present disclosure, by obtaining the feature data, then determining, according to the transformation parameters in the neural network model, a normalization mode matched with the feature data, and then performing normalization processing on the feature data according to the determined normalization mode, the purpose of autonomously learning a matched normalization mode for each normalization layer of the neural network model is implemented without human intervention, so that the present disclosure has high flexibility in performing normalization processing on the feature data, which effectively improves the adaptability of data normalization processing.

It should be understood that the above general description and the following detailed description are merely exemplary and explanatory, and are not intended to limit the present disclosure.

The other features and aspects of the present disclosure can be described more clearly according to the detailed descriptions of the exemplary embodiments in the accompanying drawings.

### BRIEF DESCRIPTION OF THE DRAWINGS

The accompanying drawings here, which are incorporated in the description and constituting a part of the description, illustrate embodiments consistent with the present disclosure and are used for explaining the technical solutions of the present disclosure together with the description.

FIG. 1a to FIG. 1c are schematic diagrams illustrating normalization modes represented by statistical ranges of statistics in a data processing method according to the embodiments of the present disclosure;

FIG. 2 is a flowchart illustrating a data processing method according to the embodiments of the present disclosure;

FIG. 3a to FIG. 3d are schematic diagrams illustrating different representation manners of transformation parameters in a data processing method according to the embodiments of the present disclosure;

FIG. 4 is a block diagram illustrating a data processing apparatus according to the embodiments of the present disclosure;

FIG. 5 is a block diagram illustrating an electronic device according to the embodiments of the present disclosure;

FIG. 6 is a block diagram illustrating an electronic device according to the embodiments of the present disclosure.

### DETAILED DESCRIPTION

Various exemplary embodiments, features, and aspects of the present disclosure are described below in detail with reference to the accompanying drawings. The same reference numerals in the accompanying drawings represent elements having the same or similar functions. Although various aspects of the embodiments are illustrated in the accompanying drawings, unless stated particularly, it is not required to draw the accompanying drawings in proportion.

The special word “exemplary” here means “used as examples, embodiments, or descriptions”. Any “exemplary” embodiment given here is not necessarily construed as being superior to or better than other embodiments.

The term “and/or” as used herein is merely the association relationship describing the associated objects, indicating that there may be three relationships, for example, A and/or B, which may indicate three cases, i.e., A exists separately, both A and B exist, and B exists separately. In addition, the term “at least one” as used herein indicates any one of multiple elements or any combination of at least two of the multiple elements, for example, including at least one of A, B, or C may indicate that any one or more elements selected from a set consisting of A, B, and C are included.

In addition, numerous specific details are given in the following specific implementations for the purpose of better explaining the present disclosure. It should be understood by persons skilled in the art that the present disclosure may still be implemented even without some of those specific details. In some examples, methods, means, elements, and circuits that are well known to persons skilled in the art are not described in detail so that the principle of the present disclosure becomes apparent.

First, it should be noted that a data processing method of the present disclosure is a technical solution of performing normalization processing on feature data (such as a feature map) in a neural network model. In a normalization layer of the neural network model, when performing normalization processing on the feature data, different normalization modes may be represented according to different statistical ranges of statistics (which may be a mean value and a variance).

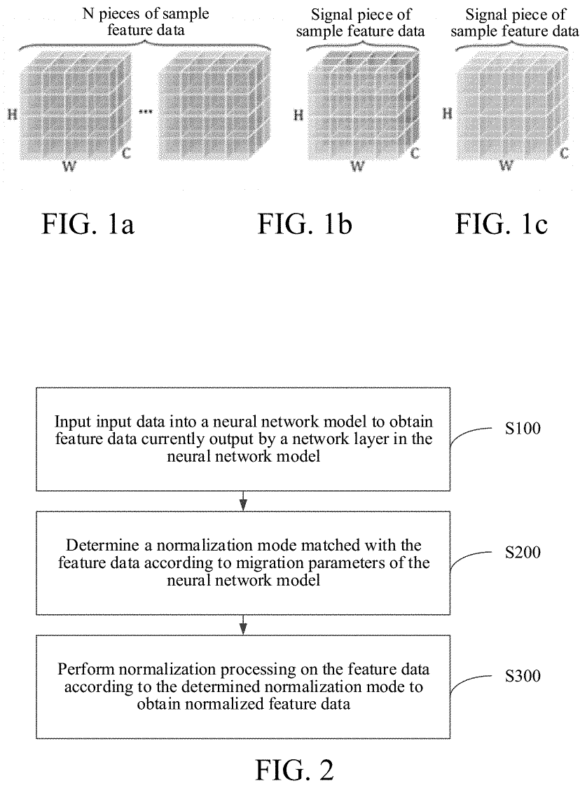

For example, FIG. 1a to FIG. 1c are schematic diagrams illustrating different normalization modes represented by different statistical ranges of statistics. With reference to FIG. 1a to FIG. 1c, when the feature data is a 4-dimensional hidden layer feature map in the neural network model, F∈R^{N×C×H×W}, where F is the feature data, R is the dimension of the feature data, N represents the number of samples in the data batch, C represents the number of channels of the feature data, and H and W represent the height and width of a single channel of the feature data, respectively.

When performing normalization processing on the feature data, statistics, i.e., a mean value μ and a variance σ², need to be first calculated on feature data F, and a normalization operation is then performed to output feature data \hat{F} having the same dimension. In related technology, the above content may be expressed by the following formula (1):

$$\hat{F} = \frac{F - {μ}^{k}}{\sqrt{{( {σ}^{k} )}^{2} + ϵ}} , where {μ}^{k} = \frac{1}{\vert {Ω}^{k} \vert} {\sum }_{( n , c , i , j ) ∈ {Ω}^{k}} {F}_{ncij} , \\ {( {σ}^{k} )}^{2} = \frac{1}{\vert {Ω}^{k} \vert} {\sum }_{( n , c , i , j ) ∈ {Ω}^{k}} {( {F}_{ncij} - {μ}^{k} )}^{2} , k ∈ \{ BN , IN , L N , GN \} . \qquad ( 1 )$$

where ϵ is a small constant to prevent the denominator from being 0, and F_{ncij}∈F is a pixel point of the c-th channel position of the n-th piece of feature data at (i, j).

With reference to FIG. 1a, the statistical range of the statistics is: Ω={(n, i, j)|n∈[1, N], i∈[1, H], j∈[1×W]}, that is, when the mean value and the variance are calculated on the same channel of N pieces of sample feature data of the feature data, the normalization mode represented in this case is Batch Normalization (BN).

With reference to FIG. 1b, the statistical range of the statistics is: Ω={(i, j)|i∈[1, H], j∈[1×W]}, that is, when the mean value and the variance are calculated on each channel of each piece of sample feature data, the represented normalization mode is Instance Normalization (IN).

With reference to FIG. 1c, the statistical range of the statistics is: Ω={(c, i, j)|c∈[1, C], i∈[1H, H], j∈[1×W]}, that is, when the mean value and the variance are calculated on all channels of each piece of sample feature data, the represented normalization mode is Layer Normalization (LN).

In addition, when the statistical range of the statistics is to calculate the mean value and the variance taking every c* channels of each piece of sample feature data as a group, the represented normalization mode is group normalization (GN), where GN is a general form of IN and LN, i.e., c*∈[1, C], and C is divided exactly by c*.

FIG. 2 is a flowchart illustrating a data processing method according to the embodiments of the present disclosure. With reference to FIG. 2, the data processing method of the present disclosure includes the following steps.

At step S100, input data is input into a neural network model to obtain feature data currently output by a network layer in the neural network model. It should be noted that the neural network model may be a Convolutional Neural Network (CNN), a Recurrent Neural Network (RNN), or a Long Short-Term Memory (LSTM) network, or is a neural network that implements various visual tasks such as image classification (ImageNet), object detection and segmentation (COCO), video recognition (Kinetics), image stylization, and note generation.

Moreover, persons skilled in the art may understand that the input data may include at least one piece of sample data. For example, the input data may contain multiple pictures, or may contain one picture. When the input data is input into the neural network model, the sample data in the input data is correspondingly processed by the neural network model. Moreover, the network layer in the neural network model may be a convolutional layer, and the input data is subjected to feature extraction by the convolutional layer to obtain corresponding feature data. When the input data includes multiple pieces of sample data, the corresponding feature data includes multiple pieces of sample feature data.

After the feature data currently output by the network layer in the neural network model is obtained, step S200 may be executed: according to transformation parameters of the neural network model, a normalization mode matched with the feature data is determined, where the transformation parameters are used for adjusting a statistical range of statistics of the feature data, and the statistical range of the statistics represents the normalization mode. Here, it should be noted that the transformation parameters are learnable parameters in the neural network model. That is, during the training process of the neural network model, transformation parameters having different values may be learned and trained according to different input data. Therefore, the learned different values of the transformation parameters are used for implementing different adjustments of the statistical range of the statistics, so as to achieve the purpose of using different normalization modes for different input data.

After the matched normalization mode is determined, step S300 may be executed: normalization processing is performed on the feature data according to the determined normalization mode to obtain normalized feature data.

Therefore, in the data processing method of the present disclosure, by obtaining the feature data, then determining, according to the transformation parameters in the neural network model, a normalization mode matched with the feature data, and then performing normalization processing on the feature data according to the determined normalization mode, the purpose of autonomously learning a matched normalization mode for each normalization layer of the neural network model is implemented without human intervention, so that the present disclosure has high flexibility in performing normalization processing on the feature data, which effectively improves the adaptability of data normalization processing.

In a possible implementation, the transformation parameters include a first transformation parameter, a second transformation parameter, a third transformation parameter, and a fourth transformation parameter, where the first transformation parameter and the second transformation parameter are used for adjusting the statistical range of the mean value in the statistics, and the third transformation parameter and the fourth transformation parameter are used for adjusting the statistical range of the standard deviation in the statistics. Moreover, the dimension of the first transformation parameter and the dimension of the third transformation parameter are both based on the batch size dimension of the feature data, and the dimension of the second transformation parameter and the dimension of the fourth transformation parameter are both based on the channel dimension of the feature data. Here, persons skilled in the art may understand that the batch size dimension is the number N of pieces of data in a data batch where the feature data is located (i.e., the number of pieces of sample feature data of the feature data), and the channel dimension is the number C of channels of the feature data.

Correspondingly, when the transformation parameters include the first transformation parameter, the second transformation parameter, the third transformation parameter, and the fourth transformation parameter, in a possible implementation, the step of determining, according to the transformation parameters of the neural network model, a normalization mode matched with the feature data may be implemented by the following steps.

First, the statistical range of the statistics of the feature data is determined as a first range. Here, it should be noted that, in a possible implementation, the first range is each channel range of each piece of sample feature data of the feature data (i.e., the statistical range of the statistics in the aforementioned IN), and may also be the statistical range of the statistics in other normalization modes.

Then, the statistical range of the mean value is adjusted from the first range to a second range according to the first transformation parameter and the second transformation parameter. Here, it should be noted that the second range is determined according to the values of the first transformation parameter and the second transformation parameter. Different values represent different statistical ranges. Moreover, the statistical range of the standard deviation is adjusted from the first range to a third range according to the third transformation parameter and the fourth transformation parameter. Similarly, the third range is determined according to the values of the third transformation parameter and the fourth transformation parameter, and different values represent different statistical ranges.

Furthermore, the normalization mode is determined based on the second range and the third range.

For example, according to the above, it can be defined that in the data processing method of the present disclosure, the normalization processing mode is:

$$\hat{F} = \frac{F - 〈 U μ V 〉}{〈 {U}^{′} σ {V}^{′} 〉} , \qquad ( 2 )$$

where F represents the feature data before normalization, \hat{F} represents the feature data after normalization, U is the first transformation parameter, V is the second transformation parameter, U′ is the third transformation parameter, and V′ is the fourth transformation parameter.

In a possible implementation, the statistical range of the statistics (the mean value μ and the standard deviation σ) may use the statistical range in the IN, that is, the statistics are calculated separately on each channel of each piece of sample feature data of the feature data, and the dimensions are all N×C. It should be noted that, according to the foregoing description, the statistical range of the statistics may also use the statistical range in other normalization modes described above. No specific definition is made here.

Therefore, an adjustment to the statistical range of the mean value in the statistics is implemented by performing a product operation on the first transformation parameter, the second transformation parameter, and the mean value, and an adjustment to the statistical range of the standard deviation is implemented by performing a product operation on the third transformation parameter, the fourth transformation parameter, and the standard deviation, so that a self-adaptive normalization mode is achieved, and the adjustment mode is simple and easy to be implemented.

In a possible implementation, the first transformation parameter U, the second transformation parameter V, the third transformation parameter U′, and the fourth transformation parameter V′ may be binarization matrices, where the value of each element in the binarization matrices is 0 or 1. That is, V′,V∈{0, 1}^{C×C} and U′,U∈{0, 1}^{N×N} are four learnable binarization matrices, respectively, each element therein being 0 or 1. Therefore, UμV and U′σV′ are normalization parameters in the data processing method of the present disclosure, and [symbol] · [symbol] operation is used for copying same in the H×W dimension to obtain the same size as F, which is convenient for matrix operations.

It can be known from the dimension of the first transformation parameter, the dimension of the second transformation parameter, the dimension of the third transformation parameter, and the dimension of the fourth transformation parameter described above that U,U′ represents a statistical mode learned in the batch size N dimension, V,V′ represents a statistical mode learned in the channel C dimension, U=U′, V=V′ represents that the same statistical modes are respectively learned for the mean value μ and the standard deviation σ, and U≠U′, V≠V′ represents that different statistical modes are respectively learned for the mean value μ and the standard deviation σ. Therefore, different U,U′,V,V′ represent different normalization methods.

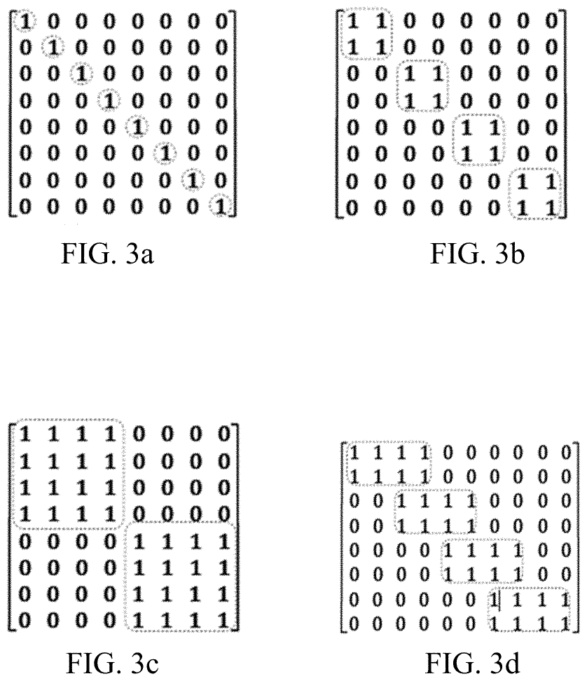

For example, with reference to FIG. 3a to FIG. 3c, when U=U′, V=V′, μ=μ^{IN}, σ=σ^{IN},

When U and V are both unit matrices I as shown in FIG. 3a, in the data processing method of the present disclosure, the normalization mode represents IN in which the statistics are calculated separately in each N dimension and each C dimension, and in this case:

Uμ^{IN}V=Iμ^{IN}I=μ^{IN}.

When U is an all-ones matrix 1 and V is a unit matrix I, in the data processing method of the present disclosure, the normalization mode represents BN in which the statistics of each C dimension are averaged in the N dimension, and in this case:

$$U {μ}^{I N} V = 1 {μ}^{I N} I = \frac{1}{n} {\sum }_{n} {μ}_{n}^{I N} = {μ}^{B N} .$$

When U is a unit matrix I and V is an all-ones matrix 1, in the data processing method of the present disclosure, the normalization mode represents LN in which the statistics of each N dimension are averaged in the C dimension, and in this case:

$$U {μ}^{I N} V = I {μ}^{I N} 1 = \frac{1}{c} {\sum }_{c} {μ}_{C}^{I N} = {μ}^{L N} .$$

When U is a unit matrix I and V is a block diagonal matrix similar to that in FIG. 3b or FIG. 3c, in the data processing method of the present disclosure, the normalization mode represents GN in which the statistics are calculated separately in the N dimension and the statistics are calculated in the C dimension by grouping. For example, when V is the block diagonal matrix shown in FIG. 3b, the number of groups is four; when V is the block diagonal matrix shown in FIG. 3c, the number of groups is two. Different from the fixed number of groups in GN the number of groups in the normalization mode may be arbitrarily learned in the data processing method of the present disclosure.

When U is an all-ones matrix 1 and V is an all-ones matrix 1, in the data processing method of the present disclosure, the normalization mode represents “BLN” in which the statistics are averaged in both N and C dimensions, that is, the mean value and the variance both have only one unique value μ̅ in (N, H, W, C), and in this case:

$$U {μ}^{I N} V = 1 {μ}^{I N} 1 = \frac{1}{c} {\sum }_{c} \frac{1}{n} {\sum }_{n} {μ}_{n c}^{I N} = \overline{μ} .$$

When U and V are both arbitrary block diagonal matrices, in the data processing method of the present disclosure, the normalization mode represents that while the statistics are calculated in the C dimension by grouping, the statistics are also calculated in the N dimension by grouping. That is to say, in the data processing method of the present disclosure, the normalization mode may learn a suitable batch size for the number of samples in one batch to evaluate the statistics.

It should be pointed out that in the above embodiments, because U=U′, V=V′, the second range determined by adjusting the statistical range of the mean value based on the first transformation parameter U and the second transformation parameter V is the same as the third range determined by adjusting the statistical range of the standard deviation based on the third transformation parameter U′ and the fourth transformation parameter V′. Persons skilled in the art may understand that when U≠U′, V≠V′, the second range and the third range obtained in this case are different, which also achieves the expansion of more diversified normalization modes. Moreover, U≠U′, V=V′, U=U′, V≠V′, and other cases may be further included, and are not listed here one by one.

In view of the above, the normalization processing mode for the feature data in the data processing method of the present disclosure is different from the normalization technique of artificially designing the statistical range in the related technology, and in the data processing method of the present disclosure, a normalization mode adapted to the current data may be autonomously learned.

That is, in the data processing method of the present disclosure, different matrices are used for representing different values of the transformation parameters (that is, the transformation parameters are represented by different matrices), so as to implement the migration of the statistics of the feature data from an initial range (i.e., the first range, such as the statistical range in the IN) to different statistical ranges, thereby autonomously learning a meta-normalization operation that depends on data, so that the data processing method of the present disclosure may not only express all the normalization techniques in the related technology, but also may expand to obtain a wider range of normalization methods, which has richer expression capabilities than previous normalization techniques.

According to the previously defined formula (2), in a possible implementation, the step of performing normalization processing on the feature data according to the determined normalization mode to obtain the normalized feature data includes the following steps.

First, the statistics of the feature data are obtained in accordance with the first range. That is, when the first range is the statistical range defined in the IN mode, in accordance with the statistical range in IN, a mean value of the feature data is calculated according to the following formula (3), and then according the calculated mean value, a standard deviation of the feature data is calculated according to the following formula (4) so as to obtain the statistics.

$$\begin{matrix}μ = \frac{1}{\vert {Ω}^{I N} \vert} {\sum }_{( n , c , i , j ) ∈ {Ω}^{IN}} {F}_{ncij} & ( 3 ) \\ σ = \frac{1}{\vert {Ω}^{I N} \vert} {\sum }_{( n , c , i , j ) ∈ {Ω}^{I N}} ( {F}_{ncij} - μ ) & ( 4 )\end{matrix}$$

Normalization processing is performed on the feature data based on the statistics, the first transformation parameter, the second transformation parameter, the third transformation parameter, and the fourth transformation parameter so as to obtain the normalized feature data.

In a possible implementation, the step of performing normalization processing on the feature data based on the statistics, the first transformation parameter, and the second transformation parameter so as to obtain the normalized feature data is implemented by the following steps.

First, a first normalization parameter is obtained based on the mean value, the first transformation parameter, and the second transformation parameter. That is, a product operation (i.e., a point multiplication operation [symbol] UμV [symbol] ) is performed on the mean value μ, the first transformation parameter U, and the second transformation parameter V to obtain the first normalization parameter ( [symbol] UμV [symbol] ). Moreover, a second normalization parameter is obtained based on the standard deviation, the third transformation parameter, and the fourth transformation parameter. That is, a product operation (i.e., a point multiplication operation [symbol] U′σV′ [symbol] ) is performed on the standard deviation σ, the third transformation parameter U′, and the fourth transformation parameter V′ to obtain the second normalization parameter ( [symbol] U′σV′ [symbol] ).

Finally, normalization processing is performed on the feature data according to the feature data, the first normalization parameter, and the second normalization parameter to obtain the normalized feature data. That is, operation processing is performed according to formula (2) to obtain the normalized feature data.

In addition, it also needs to be pointed out that in the data processing method of the present disclosure, when the feature data is subjected to normalization processing according to formula (2), after the normalization mode shown in formula (2) is applied to each convolutional layer of the neural network model, an independent normalization operation mode may be autonomously learned for each layer of feature data of the neural network model. When the feature data is subjected to normalization processing according to formula (2), there are four binarization diagonal block matrices to be learned in the normalization operation mode of each layer: the first transformation parameter U, the second transformation parameter V, the third transformation parameter U′, and the fourth transformation parameter V′. In order to further reduce the amounts of calculations and parameters in the data processing method of the present disclosure, and to change a parameter optimization process into a differentiable end-to-end mode, multiple sub-matrices may be used for an inner product operation to construct the binarization diagonal block matrices.

That is to say, in a possible implementation, the transformation parameters are synthesized by means of multiple sub-matrices. The multiple sub-matrices may be implemented by setting learnable gating parameters in the neural network model. That is, the data processing method of the present disclosure further includes: obtaining multiple corresponding sub-matrices based on the learnable gating parameters set in the neural network model, and then performing an inner product operation on the multiple sub-matrices to obtain the transformation parameters.

Here, it should be noted that the inner product operation may be a kronecker inner product operation. A matrix decomposition scheme is designed by using the kronecker inner product operation to decompose an N×N-dimensional matrix U,U′ and a C×C-dimensional matrix V,V′ into parameters having a small amount of calculations that can be accepted in a network optimization process.

For example, taking the second transformation parameter V as an example, the kronecker inner product operation is specifically described. The second transformation parameter may be expressed by a series of sub-matrices Vᵢ, which is expressed by the following formula (5):

V=f(V₁)⊗f(V₂)⊗. . . ⊗f(Vᵢ) (5)

where the dimension of each sub-matrix Vᵢ is Cᵢ×Cᵢ, Cᵢ<C and C₁×C₂× . . . ×Cᵢ=C, and ⊗ represents the kronecker inner product operation, which is an operation between two matrices of any size, and is defined as:

$$[ \begin{matrix}{a}_{11} & {a}_{12} \\ {a}_{21} & {a}_{22}\end{matrix} ] ⊗ [ \begin{matrix}{b}_{11} & {b}_{12} \\ {b}_{21} & {b}_{22}\end{matrix} ] = [ \begin{matrix}{a}_{11} {b}_{11} & {a}_{11} {b}_{12} & {a}_{12} {b}_{11} & {a}_{12} {b}_{12} \\ {a}_{11} {b}_{21} & {a}_{11} {b}_{22} & {a}_{12} {b}_{21} & {a}_{12} {b}_{22} \\ {a}_{21} {b}_{11} & {a}_{21} {b}_{12} & {a}_{22} {b}_{11} & {a}_{22} {b}_{12} \\ {a}_{21} {b}_{21} & {a}_{21} {b}_{22} & {a}_{22} {b}_{21} & {a}_{22} {b}_{22}\end{matrix} ] .$$

Therefore, after the multiple sub-matrices Vᵢ are obtained by means of the above steps, an operation is performed according to formula (5) to obtain the corresponding second transformation parameter.

The second transformation parameter is obtained by performing an inner product operation on the multiple sub-matrices Vᵢ, so that the second transformation parameter V may be decomposed into a series of sub-matries having continuous values, and the sub-matrices Vᵢ may be learned by a common optimizer without concerns about binary constraints. That is to say, the learning of the large C×C-dimensional matrix V is transformed into the learning of a series of sub-matrices Vᵢ, and the number of parameters is reduced from C² to ΣᵢCᵢ². For example, when V is an 8×8 matrix as shown in FIG. 3b, V may be decomposed into three 2×2 sub-matrices Vᵢ to perform the kronecker inner product operation, that is,

$$V = I ⊗ I ⊗ 1 = [ \begin{matrix}1 & 0 \\ 0 & 1\end{matrix} ] ⊗ [ \begin{matrix}1 & 0 \\ 0 & 1\end{matrix} ] ⊗ [ \begin{matrix}1 & 1 \\ 1 & 1\end{matrix} ] = [ \begin{matrix}1 & 0 & 0 & 0 \\ 0 & 1 & 0 & 0 \\ 0 & 0 & 1 & 0 \\ 0 & 0 & 0 & 1\end{matrix} ] ⊗ [ \begin{matrix}1 & 1 \\ 1 & 1\end{matrix} ] = [ \begin{matrix}1 & 1 & 0 & 0 & 0 & 0 & 0 & 0 \\ 1 & 1 & 0 & 0 & 0 & 0 & 0 & 0 \\ 0 & 0 & 1 & 1 & 0 & 0 & 0 & 0 \\ 0 & 0 & 1 & 1 & 0 & 0 & 0 & 0 \\ 0 & 0 & 0 & 0 & 1 & 1 & 0 & 0 \\ 0 & 0 & 0 & 0 & 1 & 1 & 0 & 0 \\ 0 & 0 & 0 & 0 & 0 & 0 & 1 & 1 \\ 0 & 0 & 0 & 0 & 0 & 0 & 1 & 1\end{matrix} ] ;$$

In this case, the number of parameters is reduced from 8²=64 to 3×2²=12.

Therefore, by using multiple sub-matrixes to synthesize a transformation parameter in the form of a large matrix, the transformation parameter learning of the second transformation parameter V in the form of a large C*C-dimensional matrix is transformed into the learning of a series of sub-matrices, and the number of parameters is reduced from C² to ΣᵢCᵢ². Persons skilled in the art may understand that the first transformation parameter U, the third transformation parameter U′, and the fourth transformation parameter V′ may also be obtained in the foregoing manner, and details are not described herein again.

In view of the above, the first transformation parameter and the second transformation parameter are synthesized by means of multiple sub-matrices, which effectively reduces the number of parameters and makes the data processing method of the present disclosure easier to be implemented.

It should be noted that in formula (5), f(•) represents an element-level transformation on each sub-matrix Vi. Therefore, in a possible implementation, f(a) may be set as a sign function, i.e., the function f(a)=sign(a), and when a≥0, sign(a)=1; when a<0, sign(a)=0, a binary matrix V may be decomposed into a series of sub-matrices having continuous values, and the sub-matrices may be learned by a common optimizer without concerns about the binary constraints, thereby implementing that the learning of the large C×C-dimensional matrix V is transformed into the learning of a series of sub-matrices Vᵢ. However, when the above policy is adopted, the transformation of the elements in the matrix by the sign function does not ensure that the constructed transformation parameter is necessarily the structure of a block diagonal matrix, which may cause that the statistical range of the statistics cannot be adjusted smoothly.

Therefore, in a possible implementation, the step of obtaining the corresponding multiple sub-matrices based on the learnable gating parameters set in the neural network model may be implemented by the following steps.

First, a sign function is used for processing the gating parameters to obtain a binarization vector.

Then, a permutation matrix is used for permuting elements in the binarization vector to generate a binarization gating vector.

Finally, the multiple sub-matrices are obtained based on the binarization gating vector, a first fundamental matrix, and a second fundamental matrix. Here, it should be pointed out that the first fundamental matrix and the second fundamental matrix are both constant matrices, where the first fundamental matrix may be an all-ones matrix, for example, the first fundamental matrix is a 2*2 all-ones matrix, and the second fundamental matrix may be a unit matrix, for example, the second fundamental matrix is a 2*2 unit matrix or a 2*3 unit matrix.

For example, according to the foregoing, the transformation parameters may include a first transformation parameter U, a second transformation parameter V, a third transformation parameter U′, and a fourth transformation parameter V′, where the manners for obtaining the first transformation parameter U, the second transformation parameter V, the third transformation parameter U′, and the fourth transformation parameter V′ are identical or similar in principle. Therefore, for the convenience of description, the second transformation parameter V is taken as an example to describe the process of synthesizing transformation parameters by using multiple sub-matrixes in more details below.

It should be pointed out that the learnable gating parameters set in the neural network model may be represented by \tilde{g}. In a possible implementation, the gating parameter \tilde{g} may be a vector having continuous values, and the number of the continuous values in the vector is consistent with the number of the obtained sub-matrices.

f(Vᵢ)=\vec{g}₁1+(1−\vec{g}ᵢ)I, ∀\vec{g}ᵢ∈\vec{g}, where \vec{g}=Pg (6)

g=sign(\tilde{g}). (7)

With reference to formula (6) and formula (7), f(·) is a binarization gating function for re-parameterizing the sub-matrices Vᵢ. In formula (7), 1 is a 2×2 all-ones matrix, I is a 2×2 unit matrix, and any \vec{g}ᵢ is a binarization gating, either 0 or 1, and \vec{g} is a vector containing multiple \vec{g}ᵢ.

In the process of obtaining the transformation parameters in the above manner, first, with reference to formula (7), the gating parameter \tilde{g} is subjected to sign to generate g, where sign(a) is a sign function; when a≥0, sign(a)=1, and when a<0, sign(a)=0. Therefore, after the gating parameter is processed by using the sign function sign(a), the obtained binarization vector g is a vector having only two values, i.e., 0 or 1.

Then, with reference to formula (7) continuously, the permutation matrix P is used for permuting the elements in the binarization vector to generate a binarization gating vector. That is, P represents a constant permutation matrix, which permutes the elements in g to generate the binarization gating in \vec{g}. It should be noted that the function of P is to control the order of 0 and 1 in the binarization gating vector \vec{g} so as to ensure that 0 is always in front of 1, i.e., to ensure that the unit matrix I is always in front of the all-ones matrix 1, so that the expressed sub-matrix Vᵢ is a block diagonal matrix. For example, when g=[1,1,0], \vec{g}=Pg=[0,1,1], and in this case, I⊗1⊗1 expresses the block diagonal matrix shown in FIG. 3c.

After using the permutation matrix to permute the elements in the binarization vector to generate the corresponding binarization gating vector \vec{g}, an operation is performed according to formula (6) based on the binarization gating vector, the first fundamental matrix 1, and the second fundamental matrix I to obtain multiple corresponding sub-matrices Vᵢ. After obtaining the multiple corresponding sub-matrices Vᵢ, an inner product operation is performed on the multiple corresponding sub-matrices Vᵢ according to formula (5) so as to obtain the corresponding second transformation parameter V.

Here, it should also be pointed out that the dimensions of the first fundamental matrix and the second fundamental matrix are not limited to the dimensions set in the above embodiments. That is to say, the dimensions of the first fundamental matrix and the second fundamental matrix may be arbitrarily selected according to an actual situation. For example, the first fundamental matrix is a 2*2 all-ones matrix 1, and the second fundamental matrix is a 2*3 unit matrix (i.e., A=[1,1,0; 0,1,1]), where A represents the second fundamental matrix. Therefore, A⊗1 expresses the block diagonal matrix having overlapping portions shown in FIG. 3d.

Therefore, different sub-matrices may be generated by using constant matrices having different dimensions (i.e., the first fundamental matrix and the second fundamental matrix), which enables the normalization mode in the data processing method of the present disclosure to be adapted to normalization layers having different number of channels, thereby further improving the expandability of the normalization mode in the method of the present disclosure.

Moreover, by setting the learnable gating parameter \tilde{g} in the neural network model, the learning of the multiple sub-matrices is transformed into the learning of the gating parameter \tilde{g}, so that in the data processing method of the present disclosure, the number of parameters during normalization is reduced from ΣᵢCᵢ² to only i parameters when an normalization operation is performed on the feature data (for example, the number of channels C of one hidden layer in the neural network model is 1024, and for a C*C-dimensional second transformation parameter V, the number of parameters thereof may be reduced to 10 parameters). Therefore, the number of parameters during the normalization is further reduced, so that the data processing method of the present disclosure is easier to be implemented and applied.

In order to more clearly describe the specific operation mode of normalizing the feature data in the data processing method of the present disclosure, the following describes the specific operation of the normalization in the data processing method of the present disclosure with one embodiment.

It should be pointed out that, in this embodiment, the first transformation parameter U and the third transformation parameter U′ are the same, and the second transformation parameter V and the fourth transformation parameter V′ are the same. Therefore, the third transformation parameter U′ and the fourth transformation parameter V′ are obtained by directly using the first gating parameter \tilde{g}^{U} corresponding to the first transformation parameter U and the second gating parameter \tilde{g}^{V} corresponding to the second transformation parameter V.

Therefore, the first gating parameter \tilde{g}^{U} and the second gating parameter \tilde{g}^{V} are respectively set in a certain normalization layer of the neural network model, the first gating parameter \tilde{g}^{U} corresponds to the first transformation parameter U, and the second gating parameter \tilde{g}^{V} corresponds to the second transformation parameter V. Moreover, a reduction parameter γ and a displacement parameter β are also set in the normalization layer. Both the reduction parameter γ and the displacement parameter β are used in a normalization formula (i.e., formula (2)).

In this embodiment, the input includes: feature data F∈R^{N×C×H×W}, learnable first gating parameter \tilde{g}^{U}∈R^{log}^{₂} ^{N×1} and learning second gating parameter \tilde{g}^{V}∈R^{log}^{₂} ^{C×1}, reduction parameter γ∈R^{C×1}, and displacement parameter β∈R^{C×1}, where \tilde{g}^{U}=0, \tilde{g}^{V}=0, γ=1, and β=0.

The output includes normalized feature data \hat{F}.

The operation in the normalization process includes

$$∀ {μ}_{n c}^{IN} = \frac{1}{H W} {\sum }_{i = 1 , j = 1}^{H , W} {F}_{n c i j} , μ ← {μ}_{n c}^{IN} ;$$

$$∀ {σ}_{n c}^{IN} = \sqrt{\frac{1}{H W} {\sum }_{i = 1 , j = 1}^{H W} {( {F}_{n c i j} - {μ}_{n c}^{IN} )}^{2} + ∈} , σ ← {σ}_{n c}^{IN} .$$

The first transformation parameter U and the second transformation parameter V are obtained by calculation according to formula (5), formula (6), and formula (7).

In this embodiment, when the feature data is normalized, the following formula (8) is finally used:

$$\hat{F} = γ \frac{F - ( U ) μ ( V )}{( U ′ ) σ ( V ′ )} + β \qquad ( 8 )$$

Persons skilled in the art may understand that when the first transformation parameter U and the third transformation parameter U′ are different, and the second transformation parameter V and the fourth transformation parameter V′ are also different, the gating parameter \tilde{g} set in the neural network model should include a first gating parameter \tilde{g}^{U}, a second gating parameter \tilde{g}^{V}, a third gating parameter \tilde{g}^{U}′, and a fourth gating parameter \tilde{g}^{V}′.

Therefore, by using the gating parameter \tilde{g} to obtain the transformation parameters in the neural network model, the transformation of the learning of the transformation parameters into the learning of the gating parameter \tilde{g} is implemented. According to formula (6) and formula (7), the sub-matrices Vᵢ are expressed by a series of all-ones matrices 1 and unit matrices I, thereby reparameterizing and transforming the learning of the sub-matrix Vᵢ in formula (5) into the learning of the vector \tilde{g} having continuous values. Moreover, the number of parameters of the transformation parameters in the form of a large matrix, such as the second transformation parameter V, is reduced from ΣᵢCᵢ² to only i parameters, thereby implementing the purpose of proposing parameter decomposition and re-parameterization by using a Kronecker operation. Therefore, the N×N-dimensional first transformation parameter U in the form of a large matrix and the C×C-dimensional second transformation parameter V in the form of a large matrix in the data processing method of the present disclosure are reduced to respectively only log₂ C and log₂ N parameters, and by using a differentiable end-to-end training mode, the data processing method of the present disclosure has a small calculation amount and a small number of parameters, and is easier to be implemented and applied.

In addition, it should be noted that the data processing method of the present disclosure may further include a training process for the neural network model. That is, before inputting the input data into the neural network model to obtain the feature data currently output by the network layer in the neural network model, the method may further include:

training the neural network model based on a sample data set to obtain a trained neural network model. Input data in the sample data set has label information.

In a possible implementation, the neural network model includes at least one network layer and at least one normalization layer. When training the neural network model based on a sample data set, first, the input data in the sample data set is subjected to feature extraction by means of a network layer to obtain corresponding prediction feature data. Then, the prediction feature data is subjected to normalization processing by means of the normalization layer to obtain normalized prediction feature data. Furthermore, a network loss is obtained according to the prediction feature data and the label information, so as to adjust the transformation parameters in the normalization layer based on the network loss.

For example, when training the neural network model, the input includes: a training data set {(xᵢ,yᵢ)}ᵢ₌₁^{P}; a series of network parameters Θ in the network layer (such as a weight value); a series of gating parameters Φ in the normalization layer (such as a first gating parameter and a second gating parameter); and a reduction parameter and a displacement parameter ψ={γ^{l},β^{l}}hd i=1^{L}. The output includes a trained neural network model (including each network layer and each normalization layer, etc.).

Here, it should be pointed out that, in this embodiment, the first transformation parameter U and the third transformation parameter U′ are the same, and the second transformation parameter V and the fourth transformation parameter V′ are also the same. Therefore, for a series of gating parameters Φ in the normalization layer, only the first gating parameter and the second gating parameter may be set.

The number of times of training is t=1toT. In each training process, according to the parameters in the above input, the normalization layer is trained according to the normalization operation process described above based on a forward propagation mode to obtain prediction feature data. According to the obtained prediction feature data and label information, the corresponding network loss is obtained based on a backward propagation mode, and then the parameters Φₜ, Θₜ, and ψₜ in the input are updated according to the obtained network loss.

After many times of training, the testing process of the neural network model may be performed. In the data processing method of the present disclosure, the testing is mainly directed to the normalization layer. Before the testing, the average values of the statistics of each normalization layer in multiple batches of training need to be calculated, and then the corresponding normalization layer is tested according to the calculated average values of the statistics. That is, the average values (μ̅^{l}, σ̅^{l}) of the statistics (the mean value μ and the standard deviation σ) of each normalization layer obtained during the multiple batches of training are calculated. The specific calculation process is: for l=1 to L, for t=1 to T),

$${\overline{μ}}^{l} += \frac{1}{T} ( {U}^{l} ) {μ}_{t}^{l} ( {V}^{l} ) , and {\overline{σ}}^{l} + = \frac{1}{T} ( {U}^{l} ) {σ}_{t}^{l} ( {V}^{l} ) .$$

After calculating the average values of the statistics of each normalization layer, the testing of each normalization layer may be performed. During the testing, for each normalization layer, the following formula (9) may be applied:

$${\hat{F}}^{l} = {γ}^{l} \frac{{F}^{l} - {\overline{μ}}^{l}}{{\overline{σ}}^{l}} + {β}^{l} \qquad ( 9 )$$

where l represents the number of layers of the normalization layer.

Therefore, after the neural network model is trained by means of the above processes, the parameters in the normalization layer in the finally trained neural network model are the first gating parameter, the second gating parameter, the reduction parameter, and the displacement parameter. In neural network models trained using different training data sets, the values of the first gating parameter and the second gating parameter of normalization layers are different, which enables the normalization modes in the data processing method of the present disclosure to be embedded in a neural network model, so that the neural network model can be applied to various visual tasks. That is, by training the neural network model, the data processing method of the present disclosure is embedded in the neural network model, and the data processing method of the present disclosure can be used to obtain a model having excellent effects in various visual tasks such as classification, detection, recognition, and segmentation, to predict the results of related tasks, or to migrate untrained neural network models (pre-trained models) to other visual tasks, and further improve the performance of other vision tasks by fine-tuning parameters (such as gating parameters in the normalization layer).

It should be understood that the foregoing various method embodiments mentioned in the present disclosure may be combined with each other to form a combined embodiment without departing from the principle logic. Details are not described herein again due to space limitation.

Moreover, persons skilled in the art can understand that, in the foregoing method of the specific implementations, the order in which the steps are written does not imply a strict execution order which constitutes any limitation to the implementation process, and the specific order of executing the steps should be determined by functions and possible internal logics thereof.

In addition, the present disclosure further provides a data processing apparatus, an electronic device, a computer-readable storage medium, and a program, which can all be used to implement any of the data processing methods provided by the present disclosure. For the corresponding technical solutions and descriptions, please refer to the corresponding content in the method section. Details are not described herein again.

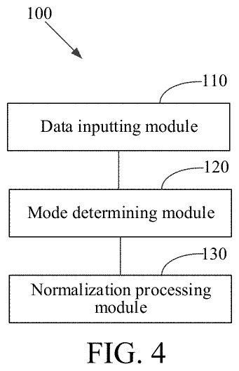

FIG. 4 is a block diagram illustrating a data processing apparatus 100 according to the embodiments of the present disclosure. As shown in FIG. 4, the data processing apparatus 100 includes:

a data inputting module 110, configured to input input data into a neural network model to obtain feature data currently output by a network layer in the neural network model;

a mode determining module 120, configured to determine, according to transformation parameters of the neural network model, a normalization mode matched with the feature data, where the transformation parameters are used for adjusting a statistical range of statistics of the feature data, and the statistical range is used for representing the normalization mode; and

a normalization processing module 130, configured to perform normalization processing on the feature data according to the determined normalization mode to obtain normalized feature data.

In a possible implementation, the apparatus further includes:

a sub-matrix obtaining module, configured to obtain multiple corresponding sub-matrices based on learnable gating parameters set in the neural network model; and

a transformation parameter obtaining module, configured to perform an inner product operation on the multiple sub-matrices to obtain the transformation parameters.

In a possible implementation, the sub-matrix obtaining module includes:

a parameter processing sub-module, configured to use a sign function to process the gating parameters to obtain a binarization vector;

an element permuting sub-module, configured to use a permutation matrix to permute elements in the binarization vector to generate a binarization gating vector; and

a sub-matrix obtaining sub-module, configured to obtain the multiple sub-matrices based on the binarization gating vector, a first fundamental matrix, and a second fundamental matrix.

In a possible implementation, the transformation parameters include a first transformation parameter, a second transformation parameter, a third transformation parameter, and a fourth transformation parameter; and

the dimension of the first transformation parameter and the dimension of the third transformation parameter are based on the batch size dimension of the feature data, and the dimension of the second transformation parameter and the dimension of the fourth transformation parameter are based on the channel dimension of the feature data;

where the batch size dimension is the number of pieces of data in a data batch where the feature data is located, and the channel dimension is the number of channels of the feature data.

In a possible implementation, the mode determining module 120 includes:

a first determining sub-module, configured to determine the statistical range of the statistics of the feature data as a first range, where the statistics include a mean value and a standard deviation;

a first adjusting sub-module, configured to adjust the statistical range of the mean value from the first range to a second range according to the first transformation parameter and the second transformation parameter;

a second adjusting sub-module, configured to adjust the statistical range of the standard deviation from the first range to a third range according to the third transformation parameter and the fourth transformation parameter; and

a mode determining sub-module, configured to determine the normalization mode based on the second range and the third range.

In a possible implementation, the first range is each channel range of each piece of sample feature data of the feature data.

In a possible implementation, the normalization processing module 130 includes:

a statistics obtaining sub-module, configured to obtain the statistics of the feature data in accordance with the first range; and

a normalization processing sub-module, configured to perform normalization processing on the feature data based on the statistics, the first transformation parameter, the second transformation parameter, the third transformation parameter, and the fourth transformation parameter so as to obtain the normalized feature data.

In a possible implementation, the normalization processing sub-module includes:

a first parameter obtaining unit, configured to obtain a first normalization parameter based on the mean value, the first transformation parameter, and the second transformation parameter;

a second parameter obtaining unit, configured to obtain a second normalization parameter based on the standard deviation, the third transformation parameter, and the fourth transformation parameter; and

a data processing unit, configured to perform normalization processing on the feature data according to the feature data, the first normalization parameter, and the second normalization parameter so as to obtain the normalized feature data.

In a possible implementation, the transformation parameters include binarization matrices, and the value of each element in the binarization matrices is 0 or 1.

In a possible implementation, the gating parameters are vectors having continuous values;

where the number of values in the gating parameters is consistent with the number of the sub-matrices.

In a possible implementation, the first fundamental matrix is an all-ones matrix, and the second fundamental matrix is a unit matrix.

In a possible implementation, the apparatus further includes:

a model training module, configured to train, before the data inputting module inputs the input data into the neural network model to obtain the feature data currently output by the network layer in the neural network model, the neural network model based on a sample data set to obtain a trained neural network model,

where input data in the sample data set has label information.

In a possible implementation, the neural network model includes at least one network layer and at least one normalization layer;

where the model training module includes:

a feature extracting sub-module, configured to perform feature extraction on the input data in the sample data set by means of the network layer to obtain prediction feature data;

a prediction feature data obtaining sub-module, configured to perform normalization processing on the prediction feature data by means of the normalization layer to obtain normalized prediction feature data;

a network loss obtaining sub-module, configured to obtain a network loss according to the prediction feature data and the label information; and

a transformation parameter adjusting sub-module, configured to adjust the transformation parameters in the normalization layer based on the network loss.

In some embodiments, the functions provided by or the modules included in the apparatus provided by the embodiments of the present disclosure may be used for implementing the method described in the foregoing method embodiments. For specific implementations, reference may be made to the description in the method embodiments above. For the purpose of brevity, details are not described herein again.

The embodiments of the present disclosure further provide a computer-readable storage medium, having computer program instructions stored thereon, where when the computer program instructions are executed by a processor, the foregoing method is implemented. The computer-readable storage medium may be a non-volatile computer-readable storage medium.

The embodiments of the present disclosure further provide an electronic device, including: a processor; and a memory configured to store processor-executable instructions, where the processor is configured to execute the foregoing method.

The electronic device may be provided as a terminal, a server, or other forms of devices.

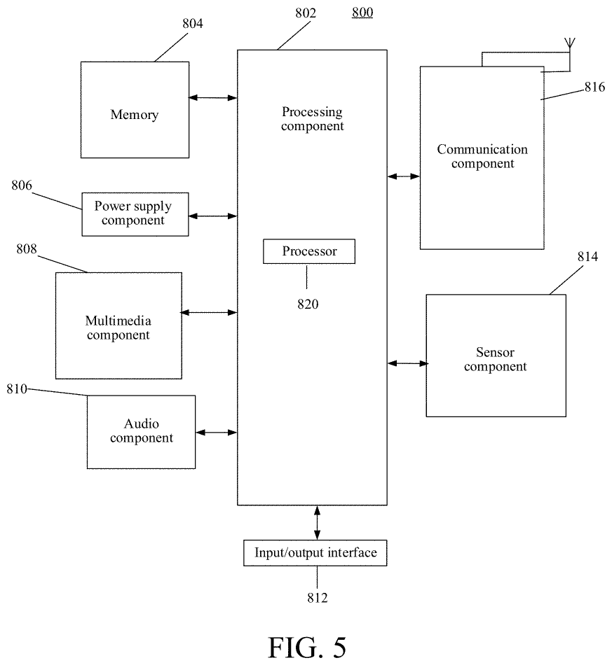

FIG. 5 is a block diagram of an electronic device 800 according to one exemplary embodiment. For example, the electronic device 800 may be a terminal such as a mobile phone, a computer, a digital broadcast terminal, a message transceiving device, a game console, a tablet device, a medical device, exercise equipment, and a personal digital assistant.

With reference to FIG. 5, the electronic device 800 may include one or more of the following components: a processing component 802, a memory 804, a power supply component 806, a multimedia component 808, an audio component 810, an Input/Output (I/O) interface 812, a sensor component 814, and a communication component 816.

The processing component 802 generally controls overall operation of the electronic device 800, such as operations associated with display, phone calls, data communications, camera operations, and recording operations. The processing component 802 may include one or more processors 820 to execute instructions to implement all or some of the steps of the method above. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations on the electronic device 800. Examples of the data include instructions for any application or method operated on the electronic device 800, contact data, contact list data, messages, pictures, videos, etc. The memory 804 may be implemented by any type of volatile or non-volatile storage device, or a combination thereof, such as a Static Random-Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a disk or an optical disk.

The power supply component 806 provides power for various components of the electronic device 800. The power supply component 806 may include a power management system, one or more power supplies, and other components associated with power generation, management, and distribution for the electronic device 800.

The multimedia component 808 includes a screen between the electronic device 800 and a user that provides an output interface. In some embodiments, the screen may include a Liquid Crystal Display (LCD) and a Touch Panel (TP). If the screen includes a TP, the screen may be implemented as a touch screen to receive input signals from the user. The TP includes one or more touch sensors for sensing touches, swipes, and gestures on the TP. The touch sensor may not only sense the boundary of a touch or swipe action, but also detect the duration and pressure related to the touch or swipe operation. In some embodiments, the multimedia component 808 includes a front-facing camera and/or a rear-facing camera. When the electronic device 800 is in an operation mode, for example, a photography mode or a video mode, the front-facing camera and/or the rear-facing camera may receive external multimedia data. Each of the front-facing camera and the rear-facing camera may be a fixed optical lens system, or have focal length and optical zooming capabilities.

The audio component 810 is configured to output and/or input an audio signal. For example, the audio component 810 includes a microphone (MIC), and the microphone is configured to receive an external audio signal when the electronic device 800 is in an operation mode, such as a calling mode, a recording mode, and a voice recognition mode. The received audio signal may be further stored in the memory 804 or transmitted by means of the communication component 816. In some embodiments, the audio component 810 further includes a speaker for outputting the audio signal.

The I/O interface 812 provides an interface between the processing component 802 and a peripheral interface module, and the peripheral interface module may be a keyboard, a click wheel, a button, etc. The button may include, but is not limited to, a home button, a volume button, a start button, and a lock button.

The sensor component 814 includes one or more sensors for providing state assessment in various aspects for the electronic device 800. For example, the sensor component 814 may detect an on/off state of the electronic device 800, and relative positioning of components, which are the display and keypad of the electronic device 800, for example, and the sensor component 814 may further detect a position change of the electronic device 800 or one component of the electronic device 800, the presence or absence of contact of the user with the electronic device 800, the orientation or acceleration/deceleration of the electronic device 800, and a temperature change of the electronic device 800. The sensor component 814 may include a proximity sensor, which is configured to detect the presence of a nearby object when there is no physical contact. The sensor component 814 may further include a light sensor, such as a CMOS or CCD image sensor, for use in an imaging application. In some embodiments, the sensor component 814 may further include an acceleration sensor, a gyroscope sensor, a magnetic sensor, a pressure sensor, or a temperature sensor.

The communication component 816 is configured to facilitate wired or wireless communications between the electronic device 800 and other devices. The electronic device 800 may access a wireless network based on a communication standard, such as Wi-Fi, 2G, or 3G, or a combination thereof. In one exemplary embodiment, the communication component 816 receives a broadcast signal or broadcast-related information from an external broadcast management system by means of a broadcast channel. In one exemplary embodiment, the communication component 816 further includes a Near Field Communication (NFC) module to facilitate short-range communication. For example, the NFC module may be implemented based on Radio Frequency Identification (RFID) technology, Infrared Data Association (IrDA) technology, Ultra-Wideband (UWB) technology, Bluetooth (BT) technology, and other technologies.

In an exemplary embodiment, the electronic device 800 may be implemented by one or more Application-Specific Integrated Circuits (ASICs), Digital Signal Processors (DSPs), Digital Signal Processing Devices (DSPDs), Programmable Logic Devices (PLDs), Field-Programmable Gate Arrays (FPGAs), controllers, microcontrollers, microprocessors, or other electronic elements, to execute the method above.

In an exemplary embodiment, a non-volatile computer-readable storage medium is further provided, for example, a memory 804 including computer program instructions, which can be executed by the processor 820 of the electronic device 800 to implement the method above.

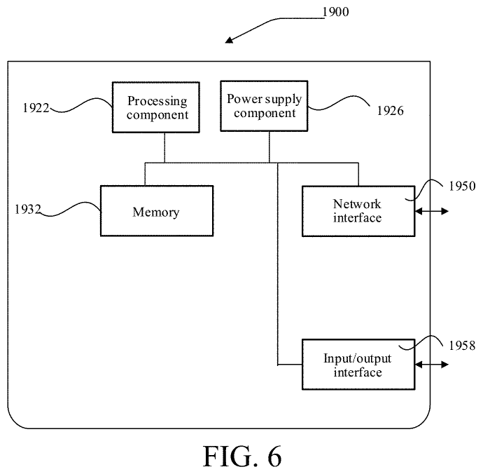

FIG. 6 is a block diagram of an electronic device 1900 according to one exemplary embodiment. For example, the electronic device 1900 may be provided as a server. With reference to FIG. 6, the electronic device 1900 includes a processing component 1922 which further includes one or more processors, and a memory resource represented by a memory 1932 and configured to store instructions executable by the processing component 1922, for example, an application program. The application program stored in the memory 1932 may include one or more modules, each of which corresponds to a set of instructions. In addition, the processing component 1922 is configured to execute instructions so as to execute the method above.

The electronic device 1900 may further include one power supply component 1926 configured to execute power management of the electronic device 1900, one wired or wireless network interface 1950 configured to connect the electronic device 1900 to the network, and one input/output (I/O) interface 1958. The electronic device 1900 may be operated based on an operating system stored in the memory 1932, such as Windows Server™, Mac OS X™, Unix™, Linux™, FreeBSD™ or the like.

In an exemplary embodiment, a non-volatile computer-readable storage medium is further provided, for example, a memory 1932 including computer program instructions, which can executed by the processing component 1922 of the electronic device 1900 to implement the method above.

The present disclosure may be a system, a method, and/or a computer program product. The computer program product may include a computer-readable storage medium having computer-readable program instructions thereon for causing a processor to implement the aspects of the present disclosure.

The computer-readable storage medium may be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. More specific examples (a non-exhaustive list) of the computer-readable storage medium include: a portable computer diskette, a hard disk, an RAM, an ROM, an EPROM or Flash memory, a SRAM, a portable Compact Disk Read-Only Memory (CD-ROM), a Digital Versatile Disc (DVD), a memory stick, a floppy disk, a mechanically encoded device such as punch-cards or raised structure in a groove having instructions stored thereon, and any suitable combination of the foregoing. The computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer-readable program instructions described herein can be downloaded to respective computing/processing devices from a computer-readable storage medium or to an external computer or external storage device via a network, for example, the Internet, a Local Area Network (LAN), a Wide Area Network (WAN), and/or a wireless network. The network may include copper transmission cables, optical fiber transmission, wireless transmission, routers, firewalls, switches, gateway computers, and/or edge servers. A network adapter card or a network interface in each computing/processing device receives computer-readable program instructions from the network and forwards the computer-readable program instructions for storage in a computer-readable storage medium within the respective computing/processing device.

The computer program instructions for performing the operations of the present disclosure may be assembler instructions, instruction-set-architecture (ISA) instructions, machine instructions, machine dependent instructions, microcode, firmware instructions, state-setting data, or either source code or object code written in one of or any combination of multiple programming languages, including an object oriented programming language such as Smalltalk, C++ or the like, and conventional procedural programming languages, such as the “C” programming language or similar programming languages. The computer-readable program instructions may be executed entirely on a user's computer, partly on the user's computer, as a stand-alone software package, partly on the user's computer and partly on a remote computer or entirely on a remote computer or a server. In a scenario involving a remote computer, the remote computer may be connected to the user's computer by means of any type of network, including a LAN or a WAN, or the connection may be made to an external computer (for example, by means of the Internet using an Internet service provider). In some embodiments, electronic circuitry including, for example, programmable logic circuitry, FGPAs, or Programmable Logic Arrays (PLAs), may execute the computer-readable program instructions by utilizing state information of the computer-readable program instructions to personalize the electronic circuitry, so as to implement the aspects of the present disclosure.

The aspects of the present disclosure are described herein with reference to flowcharts and/or block diagrams of methods, apparatuses (systems), and computer program products according to the embodiments of the present disclosure. It should be understood that each block of the flowcharts and/or block diagrams, and combinations of the blocks in the flowcharts and/or block diagrams can be implemented by computer-readable program instructions.

These computer-readable program instructions may be provided to a processor of a general-purpose computer, special-purpose computer, or other programmable data processing apparatus to produce a machine, such that the instructions, which are executed via the processor of the computer or other programmable data processing apparatus, create means for implementing the functions/actions specified in one or more blocks of the flowcharts and/or block diagrams. These computer-readable program instructions may also be stored in a computer-readable storage medium and can cause a computer, a programmable data processing apparatus, and/or other devices to function in a particular manner, such that the computer-readable medium having instructions stored thereon includes an article of manufacture including instructions which implement the aspects of the functions/actions specified in one or more blocks of the flowcharts and/or block diagrams.

The computer-readable program instructions may also be loaded onto a computer, other programmable data processing apparatuses, or other devices to cause a series of operational steps to be executed on the computer, other programmable data processing apparatuses or other devices to produce a computer implemented process, such that the instructions which are executed on the computer, other programmable data processing apparatuses or other devices implement the functions/actions specified in one or more blocks of the flowcharts and/or block diagrams.

The flowcharts and block diagrams in the accompanying drawings illustrate the architecture, functionality and operations of possible implementations of systems, methods, and computer program products according to multiple embodiments of the present disclosure. In this regard, each block in the flowcharts or block diagrams may represent a module, segment, or part of an instruction, which includes one or more executable instructions for implementing the specified logical function(s). In some alternative implementations, the functions noted in the block may also occur out of the order noted in the accompanying drawings. For example, two consecutive blocks may actually be executed substantially in parallel, or the blocks may sometimes be executed in the reverse order, depending upon the functionality involved. It should also be noted that each block in the block diagrams and/or flowcharts, and combinations of blocks in the block diagrams and/or flowcharts, can be implemented by special-purpose hardware-based systems that perform the specified functions or actions or carried out by combinations of special-purpose hardware and computer instructions.

The descriptions of the embodiments of the present disclosure have been presented for purposes of illustration, but are not intended to be exhaustive or limited to the embodiments disclosed. Many modifications and variations will be obvious to persons of ordinary skill in the art without departing from the scope and spirit of the described embodiments. The terminology used herein was chosen to best explain the principles of the embodiments, the practical application or technical improvement over technologies found in the marketplace, or to enable other persons of ordinary skill in the art to understand the embodiments disclosed herein.

1. A data processing method, comprising:
inputting input data into a neural network model to obtain feature data currently output by a network layer in the neural network model;
determining, according to transformation parameters of the neural network model, a normalization mode matched with the feature data, wherein the transformation parameters are used for adjusting a statistical range of statistics of the feature data, and the statistical range is used for representing the normalization mode; and
performing normalization processing on the feature data according to the determined normalization mode to obtain normalized feature data.

2. The method according to claim 1, further comprising:
obtaining multiple corresponding sub-matrices based on learnable gating parameters set in the neural network model; and
performing inner product operation on the multiple sub-matrices to obtain the transformation parameters.

3. The method according to claim 2, wherein obtaining the multiple corresponding sub-matrices based on the learnable gating parameters set in the neural network model comprises:
using a sign function to process the gating parameters to obtain a binarization vector;
using a permutation matrix to permute elements in the binarization vector to generate a binarization gating vector; and
obtaining the multiple sub-matrices based on the binarization gating vector, a first fundamental matrix, and a second fundamental matrix.

4. The method according to claim 1, wherein the transformation parameters comprise a first transformation parameter, a second transformation parameter, a third transformation parameter, and a fourth transformation parameter; and
a dimension of the first transformation parameter and a dimension of the third transformation parameter are based on a batch size dimension of the feature data, and a dimension of the second transformation parameter and a dimension of the fourth transformation parameter are based on a channel dimension of the feature data;
wherein the batch size dimension is the number of pieces of data in a data batch where the feature data is located, and the channel dimension is the number of channels of the feature data.

5. The method according to claim 4, wherein determining, according to the transformation parameters of the neural network model, the normalization mode matched with the feature data comprises:
determining the statistical range of the statistics of the feature data as a first range, wherein the statistics comprise a mean value and a standard deviation;
adjusting the statistical range of the mean value from the first range to a second range according to the first transformation parameter and the second transformation parameter;
adjusting the statistical range of the standard deviation from the first range to a third range according to the third transformation parameter and the fourth transformation parameter; and
determining the normalization mode based on the second range and the third range.

6. The method according to claim 4, wherein the first range is each channel range of each piece of sample feature data of the feature data.

7. The method according to claim 5, wherein performing normalization processing on the feature data according to the determined normalization mode to obtain the normalized feature data comprises:
obtaining the statistics of the feature data in accordance with the first range; and
performing normalization processing on the feature data based on the statistics, the first transformation parameter, the second transformation parameter, the third transformation parameter, and the fourth transformation parameter so as to obtain the normalized feature data.

8. The method according to claim 7, wherein performing normalization processing on the feature data based on the statistics, the first transformation parameter, the second transformation parameter, the third transformation parameter, and the fourth transformation parameter so as to obtain the normalized feature data comprises:
obtaining a first normalization parameter based on the mean value, the first transformation parameter, and the second transformation parameter;
obtaining a second normalization parameter based on the standard deviation, the third transformation parameter, and the fourth transformation parameter; and
performing normalization processing on the feature data according to the feature data, the first normalization parameter, and the second normalization parameter so as to obtain the normalized feature data.

9. The method according to claim 1, wherein the transformation parameters comprise binarization matrices, and the value of each element in the binarization matrices is 0 or 1.

10. The method according to claim 2, wherein the gating parameters are vectors having continuous values;
wherein the number of values in the gating parameters is consistent with the number of the sub-matrices.

11. The method according to claim 3, wherein the first fundamental matrix is an all-ones matrix, and the second fundamental matrix is a unit matrix.

12. The method according to claim 1, wherein before inputting the input data into the neural network model to obtain the feature data currently output by the network layer in the neural network model, the method further comprises:
training the neural network model based on a sample data set to obtain a trained neural network model,
wherein input data in the sample data set has label information.

13. The method according to claim 12, wherein the neural network model comprises at least one network layer and at least one normalization layer;
wherein training the neural network model based on the sample data set comprises:
performing feature extraction on the input data in the sample data set by means of the network layer to obtain prediction feature data;
performing normalization processing on the prediction feature data by means of the normalization layer to obtain normalized prediction feature data;
obtaining a network loss according to the prediction feature data and the label information; and
adjusting the transformation parameters in the normalization layer based on the network loss.

14. A data processing apparatus, comprising:
a processor; and
a memory configured to store processor-executable instructions,
wherein the processor is configured to invoke the instructions stored in the memory, so as to:
input input data into a neural network model to obtain feature data currently output by a network layer in the neural network model;
determine, according to transformation parameters of the neural network model, a normalization mode matched with the feature data, wherein the transformation parameters are used for adjusting a statistical range of statistics of the feature data, and the statistical range is used for representing the normalization mode; and
perform normalization processing on the feature data according to the determined normalization mode to obtain normalized feature data.

15. The apparatus according to claim 14, wherein the processor is further configured to:
obtain multiple corresponding sub-matrices based on learnable gating parameters set in the neural network model; and
perform inner product operation on the multiple sub-matrices to obtain the transformation parameters.

16. The apparatus according to claim 15, wherein obtaining multiple corresponding sub-matrices based on learnable gating parameters set in the neural network model comprises:
using a sign function to process the gating parameters to obtain a binarization vector;
using a permutation matrix to permute elements in the binarization vector to generate a binarization gating vector; and
obtaining the multiple sub-matrices based on the binarization gating vector, a first fundamental matrix, and a second fundamental matrix.

17. The apparatus according to claim 14, wherein the transformation parameters comprise a first transformation parameter, a second transformation parameter, a third transformation parameter, and a fourth transformation parameter; and
a dimension of the first transformation parameter and a dimension of the third transformation parameter are based on a batch size dimension of the feature data, and a dimension of the second transformation parameter and a dimension of the fourth transformation parameter are based on a channel dimension of the feature data;
wherein the batch size dimension is the number of pieces of data in a data batch where the feature data is located, and the channel dimension is the number of channels of the feature data.

18. The apparatus according to claim 17, wherein determining, according to the transformation parameters of the neural network model, the normalization mode matched with the feature data comprises:
determining the statistical range of the statistics of the feature data as a first range, wherein the statistics comprise a mean value and a standard deviation;
adjusting the statistical range of the mean value from the first range to a second range according to the first transformation parameter and the second transformation parameter;
adjusting the statistical range of the standard deviation from the first range to a third range according to the third transformation parameter and the fourth transformation parameter; and
determining the normalization mode based on the second range and the third range.

19. The apparatus according to claim 18, wherein the first range is each channel range of each piece of sample feature data of the feature data.

20. A non-transitory computer-readable storage medium, having computer program instructions stored thereon, wherein when the computer program instructions are executed by a processor, the processor is caused to perform the operations of:
inputting input data into a neural network model to obtain feature data currently output by a network layer in the neural network model;
determining, according to transformation parameters of the neural network model, a normalization mode matched with the feature data, wherein the transformation parameters are used for adjusting a statistical range of statistics of the feature data, and the statistical range is used for representing the normalization mode; and
performing normalization processing on the feature data according to the determined normalization mode to obtain normalized feature data.
